(19) United States
(12) Patent Application Publication
(10) Pub. No.: US 2010/0030960 A1
(43) Pub. Date: Feb. 4, 2010

(54) RAID ACROSS VIRTUAL DRIVES

(76) Inventors: Hariharan Kamalavannan, Chennai (IN); Senthil Kannan, Pondicherry (IN); P. Padmanabhan, Krishnagiri (IN); Satish Subramanian, Chennai (IN)

Correspondence Address: COCHRAN FREUND & YOUNG LLC;LSI CORPORATION, 2026 CARIBOU DRIVE, SUITE 201, FORT COLLINS, CO, 80525, US

(21) Appl. No.: 12/183,262

(22) Filed: Jul. 31, 2008

(51) Int. Cl. G06F 12/00

(52) U.S. Cl. 711/114; 711/E12.001

(57) ABSTRACT

A plurality of physical drives is grouped into a physical drive group. The plurality of physical drives comprises at least a first physical drive and a second physical drive. At least the first physical drive and the second physical drive are striped to create at least a first virtual drive and a second virtual drive. The first virtual drive is comprised of storage space residing on the first physical drive and the second virtual drive is comprised of storage space residing on the second physical drive. Storage data is distributed across at least the first virtual drive and the second virtual drive using at least one redundant array of independent disks (RAID) technique to create at least a first virtual volume and a second virtual volume. When a physical drive fails, data from the failed physical drive may be reconstructed using temporary stripes from a virtual drive.

### BACKGROUND OF THE INVENTION

Mass storage systems continue to provide increased storage capacities to satisfy user demands. Photo and movie storage, and photo and movie sharing are examples of applications that fuel the growth in demand for larger and larger storage systems.

A solution to these increasing demands is the use of arrays of multiple inexpensive disks. These arrays may be configured in ways that provide redundancy and error recovery without any loss of data. These arrays may also be configured to increase read and write performance by allowing data to be read or written simultaneously to multiple disk drives. These arrays may also be configured to allow “hot-swapping” which allows a failed disk to be replaced without interrupting the storage services of the array. Whether or not any redundancy is provided, these arrays are commonly referred to as redundant arrays of independent disks (or more commonly by the acronym RAID). The 1987 publication by David A. Patterson, et al., from the University of California at Berkeley titled “A Case for Redundant Arrays of Inexpensive Disks (RAID)” discusses the fundamental concepts and levels of RAID technology.

RAID storage systems typically utilize a controller that shields the user or host system from the details of managing the storage array. The controller makes the storage array appear as one or more disk drives (or volumes). This is accomplished in spite of the fact that the data (or redundant data) for a particular volume may be spread across multiple disk drives.

### SUMMARY OF THE INVENTION

An embodiment of the invention may therefore comprise a method of providing virtual volumes to at least one host, comprising: grouping a plurality of physical drives into a physical drive group, wherein the plurality of physical drives comprises at least a first physical drive and a second physical drive; striping at least the first physical drive and the second physical drive to create a plurality of virtual drives comprising at least a first virtual drive and a second virtual drive wherein the first virtual drive comprises storage space residing on the first physical drive and the second virtual drive comprises storage space residing on the second physical drive; and, distributing storage data across at least the first virtual drive and the second virtual drive using at least one redundant array of independent disks (RAID) technique to create a plurality of virtual volumes comprising at least a first virtual volume and a second virtual volume.

An embodiment of the invention may therefore further comprise a storage system, comprising: a physical drive grouper configured to provide a plurality of virtual drives that stripes a plurality of physical disks to provide a storage pool that utilizes RAID level 0; a storage virtualization manager configured to provide at least a first virtual volume to a first host that stripes the plurality of virtual drives to configure the first virtual volume with a first RAID level.

An embodiment of the invention may therefore further comprise a computer readable medium having instructions stored thereon for providing virtual volumes to at least one host that, when executed by a computer, at least direct the computer to: group a plurality of physical drives into a physical drive group, wherein the plurality of physical drives comprises at least a first physical drive and a second physical drive; stripe storage data across at least the first physical drive and the second physical drive to create a plurality of virtual drives comprising at least a first virtual drive and a second virtual drive; and, distribute storage data across at least the first virtual drive and the second virtual drive using at least one redundant array of independent disks (RAID) technique to create a plurality of virtual volumes comprising at least a first virtual volume and a second virtual volume.

### BRIEF DESCRIPTION OF THE DRAWINGS

FIG. 1 is a block diagram illustrating a storage system.

FIG. 2 is a block diagram illustrating functional layers of a storage system.

FIG. 3 is a flowchart illustrating a method of providing a virtual volume to a host.

FIG. 4 is a flowchart illustrating a method of providing multiple RAID virtual volumes to a host.

### DETAILED DESCRIPTION OF THE EMBODIMENTS

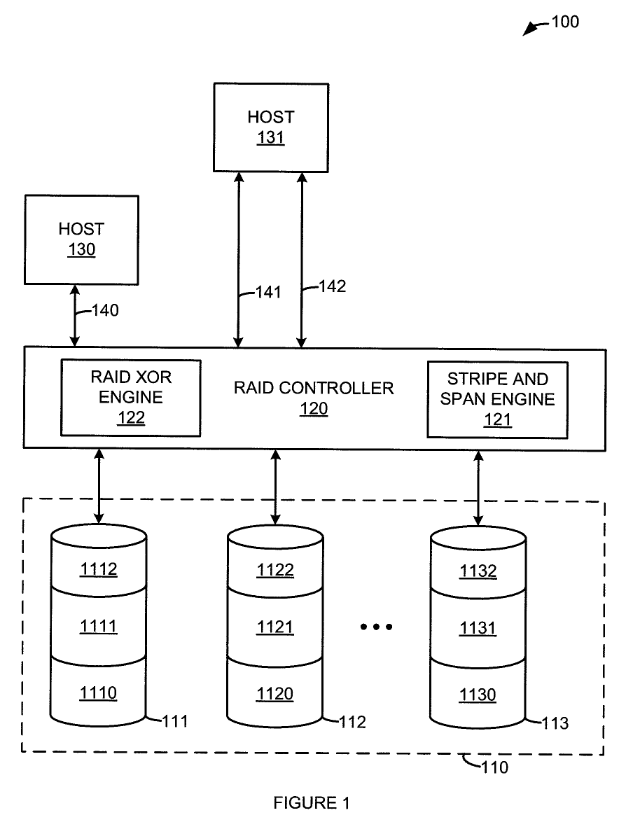

FIG. 1 is a block diagram illustrating a storage system. In FIG. 1, storage system 100 is comprised of disk array 110, RAID controller 120, host 130, host 131, virtual volume 140, virtual volume 141, and virtual volume 142. Disk array 110 includes at least first physical drive 111, second physical drive 112, and third physical drive 113. Disk array 110 may also include more disk drives. However, these are omitted from FIG. 1 for the sake of brevity. First physical drive 111 is partitioned into partitions 1110, 1111, and 1112. Second physical drive 112 is partitioned into partitions 1120, 1121, and 1122. Third physical drive 113 is partitioned into partitions 1130, 1131, and 1132.

Disk array 110, and physical drives 111-113 are operatively coupled to RAID controller 120. Thus, raid controller 120 may operate to control, span, and/or stripe physical drives 111-113 and partitions 1110-1112, 1120-1122, and 1130-1132.

Raid controller 120 includes stripe and span engine 121. Stripe and span engine 121 may be a module or process that stripes and/or spans physical drives 111-113 based on partitions 1110-1112, 1120-1122, and 1130-1132, respectively. Stripe and span engine 121 may include dedicated hardware to increase the performance of striped and/or spanned accesses to physical drives 111-113 or partitions 1110-1112, 1120-1122, and 1130-1132. Stripe and span engine 121 may create virtual drives by striping and/or spanning storage space on physical drives 111-113 and/or partitions 1110-1112, 1120-1122, and 1130-1132.

In an embodiment, stripe and span engine 121 creates a plurality of virtual drives by striping storage space on an individual physical drive 111-113 and then projecting the striped storage space as an individual virtual drive. In other words, stripe and span engine 121 creates virtual drives whose data is entirely stored on a single physical drive 111-113. These virtual drives may appear to RAID controller 120, or other software modules, as unstriped disk drives. The virtual drives are, in essence, a RAID level 0 configuration to make use of the entire capacity of each physical drive 111-113. Thus, the entire storage space of each physical drive 111-113 may be projected as a virtual drive without regard to the storage space of the other physical drives 111-113.

Raid controller 122 includes RAID XOR engine 122. RAID XOR engine 122 may be a module, process, or hardware that creates various RAID levels utilizing virtual drives created and projected by stripe and span engine 121. In an embodiment, RAID XOR engine may create RAID levels 1 through 6 utilizing the virtual drives created and projected by stripe and span engine 121. The stripes required for each RAID level may be grouped among the virtual drives without regard to the underlying physical stripes created by stripe and span engine 121.

RAID controller 120 may project virtual volume 140 to host 130. RAID controller 120 may project virtual volumes 141-142 to host 131. RAID controller 120 may also project additional virtual volumes. However, these are omitted from FIG. 1 for the sake of brevity. Once created from the RAID configurations, virtual volumes 140-142 may be accessed by host computers. Virtual volumes 140-142 may each have different RAID levels. For example, virtual volume 140 may be configured as RAID level 1. Virtual volume 141 may be configured as RAID level 5. Virtual volume 142 may be configured as RAID level 6.

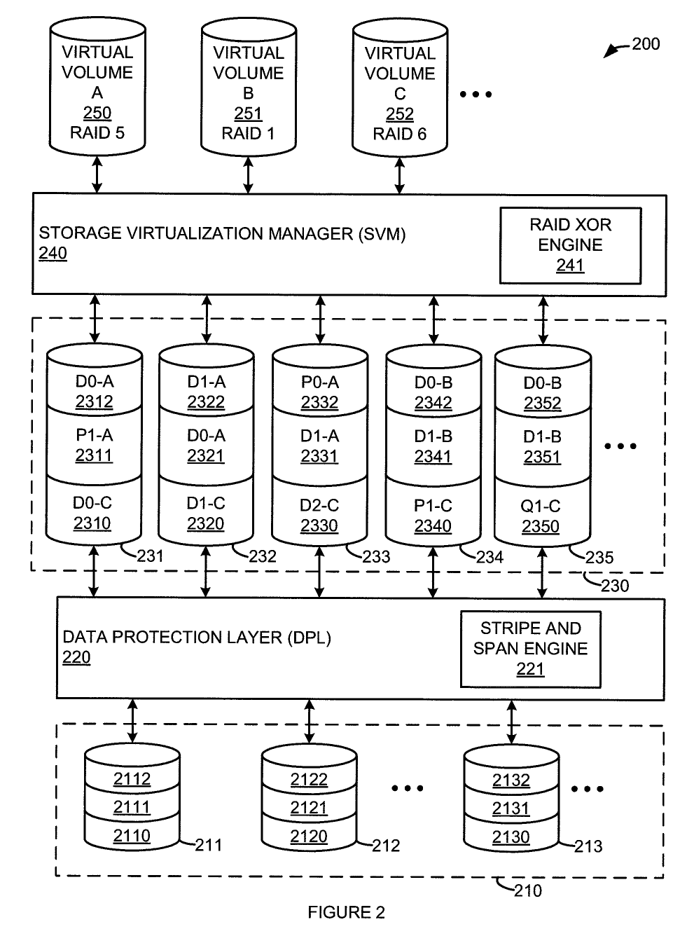

FIG. 2 is a block diagram illustrating functional layers of a storage system. In FIG. 2, storage system 200 comprises: disk group 210; data protection layer (DPL) 220; storage pool 230; storage virtualization manager (SVM) 240; virtual volume A 250; virtual volume B 251; and, virtual volume C 252.

Disk group 210 includes disk drive 211, disk drive 212, and disk drive 213. Disk drives 211-213 may also be referred to as physical drives. Disk group 210 may also include more disk drives. However, these are omitted from FIG. 2 for the sake of brevity. Disk drive 211 includes partition 2110, partition 2111, and partition 2112. Disk drive 212 includes partition 2120, partition 2121, and partition 2122. Disk drive 213 includes partition 2130, partition 2131, and partition 2132.

Disk group 210 and disk drives 211-213 are operatively coupled to data protection layer 220. Data protection layer 220 includes stripe and span engine 221. Data protection layer 220 is operatively coupled to storage pool 230. Storage pool 230 includes virtual drive 231, virtual drive 232, virtual drive 233, virtual drive 234, and virtual drive 235. Storage pool 230 may include additional virtual drives. However, for the sake of brevity, these have been omitted from FIG. 2. Each of the virtual drives 231-235 is operatively coupled to data protection layer 220. Each of the virtual drives 231-235 is also operatively coupled to SVM 240.

Virtual drive 231 includes stripes D0-C 2310, P1-A 2311, and D0-A 2312. Virtual drive 232 includes stripes D1-C 2320, D0-A 2321, and D1-A 2322. Virtual drive 233 includes stripes D2-C 2330, D1-A 2331, and P0-A 2332. Virtual drive 234 includes stripes P1-C 2340, D1-B 2341, and D0-B 2342. Virtual drive 235 includes stripes Q1-C 2350, D1-B 2351, and D0-B 2352.

The naming of stripes 2310-2350 is intended to convey the type of data stored, and the virtual volume to which that data belongs. Thus, the name D0-A for stripe 2312 is intended to convey that stripe 2312 contains data block 0 (e.g., D0) for virtual volume A 250. D0-C is intended to convey that stripe 2310 contains data block 0 for virtual volume C 252. P0-A is intended to convey that stripe 2332 contains parity block 0 for virtual volume A 252. Q1-C is intended to convey that stripe 2350 contains second parity block 1 for virtual volume C 252, and so on.

SVM 240 includes RAID XOR engine 241. SVM 240 is operatively coupled to virtual volume A 250, virtual volume B 251, and virtual volume C 252. In should be understood that virtual volumes 250-252 may be accessed by host computers (not shown). These host computers would typically access virtual volumes 250-252 without knowledge of the underlying RAID structures created by SVM 240 and RAID XOR engine 241 from storage pool 230. These host computers would also typically access virtual volumes 250-252 without knowledge of the underlying striping and spanning used by DPL 220 and stripe and span engine 221 to create virtual drives 231-235 and storage pool 230. These host computers would also typically access virtual volumes 250-252 without knowledge of the underlying characteristics of disk group 210 and disk drives 211-213.

In FIG. 2, disk drives 211-213 are typically separate physical storage devices such as hard disk drives. DPL 220 and SVM 240 are typically software modules or processes that run on a storage array controller. However, DPL 220 and/or SVM 240 may be assisted by hardware accelerators. In an embodiment, these hardware accelerators may perform some of the functions of stripe and span engine 221 or RAID XOR engine 241, or both. Storage pool 230, virtual drives 231-235, and virtual volumes 250-252 are functional abstractions intended to convey how various software components (such as DPL 220 and SVM 240) interact with each other, and hardware components (such as host computers). An example of a functional abstraction is a software application programming interface (API).

Storage system 200 functions as follows: DPL 220 groups disk drives 211-213 into drive group 210. Each disk drive 211-213 is striped by DPL 220 to create and project virtual drives 231-235 to SVM 240. DPL 220 may use stripe and span engine 221 to create and project virtual drives 231-235 to SVM 240. Each disk drive 211-213 is striped and projected as an individual virtual drive. (E.g., disk drive 211 may be projected as virtual drive 231. Disk drive 212 may be projected as virtual drive 232, and so on.) This way of striping and spanning effectively creates virtual drives 231-235 that are configured as RAID level 0. This way of striping and spanning effectively allows the entire capacity of disk drives 211-213 to be translated to virtual drives 231-235. DPL may project virtual drives 231-235 by providing SVM 240 with unique logical unit numbers (LUNs) for each virtual drive 231-235. These LUNs may be used by SVM 240 to access virtual drives 231-235.

SVM 240 groups virtual drives 231-235 into storage pool 230. SVM 240 creates a plurality of RAID levels on storage pool 230. SVM 240 may use a hardware accelerated RAID XOR engine 241 to help create the plurality of RAID levels on storage pool 230. In an embodiment, SVM 240 can configure any RAID level 0-6 using storage pool 230. The stripes 2310-2350 required for a particular RAID level and virtual volume 250-252 are selected by SVM 240 from storage pool 230. The stripes 2310-2350 used for a particular virtual volume 250-252 may be dynamically allocated from storage pool 230 and assigned to a virtual volume 250-252. SVM 240 creates virtual volumes 250-252 and projects these to host computers. SVM 240 may project virtual volumes 250-252 by providing LUNs for each virtual volume 250-252. These LUNs may be used by host computers to access virtual volumes 250-252.

The formation of virtual volumes 250-252 can be further illustrated by the stripes 2310-2350 in storage pool 230. Note that stripes 2312, 2322, 2332, 2311, 2321 and 2331 contain D0, D1, P0, P1, D0, and D1 data, respectively. Since stripes 2312, 2322, 2332, 2311, 2321 and 2331 contain data for virtual volume A, it can be seen that virtual volume A is configured at RAID level 5. Likewise, it can be seen that virtual volume B is configure at RAID level 1 and virtual volume C is configured at RAID level 6.

In the case of a failure of a disk drive 211-213, the corresponding virtual drive 231-233 will also experience a failure. This results in degraded performance or reliability of the virtual volumes 250-252 associated with the failed virtual drive 231-233. Typically, this will also trigger a warning indicating that a replacement of the failed disk drive 211-213 should be performed.

In an example, when a disk drive 211-213 fails, storage system 200 may reconstruct the information on the stripes of the failed disk drive 211-213 (and thus, also on virtual drive 231-233) before the failed disk drive 211-213 is replaced. This may be accomplished as follows: (1) DPL 220 searches for an unused or unallocated stripe set that is equivalent to the stripe sets on the failed virtual disk 231-233 associated with the failed disk drive 211-213; (2) DPL communicates the equivalent stripe sets to SVM 240 and RAID XOR engine 241; (3) SVM 240 allocates the equivalent stripe sets from storage pool 230 as temporary replacement stripes; and, (4) RAID XOR engine 241 reconstructs the information that was previously stored on the failed stripe sets and stores it on the temporary replacement stripes. The reconstructed information may then be read and written using the temporary replacement stripes.

Until the failed disk drive 211-213 is replaced, the temporary replacement stripes are not available to be used for virtual volume 250-252 creation or expansion. When the failed disk drive 211-213 is replaced, the information on the temporary replacement stripes may be copied to the stripes of the newly restored virtual drive 231-233 (and thus the information is also copied to the newly installed disk drive 211-213). After the replacement stripes have been copied, the temporary replacement stripes may be de-allocated and become available to be used for virtual volume 250-252 create or expansion.

In another example, when a disk drive 211-213 fails, storage system 200 may reconstruct the information on the stripes of the failed virtual drive 231-233 after the failed disk drive 211-213 is replaced. This may be accomplished by replacing the failed disk drive 211-213 with a new disk drive 211-213 of the same capacity. Once the failed disk drive 211-213 is replaced, DPL 220 stripes the new disk drive 211-213 and informs SVM 240 and RAID XOR engine 241 of a new, but empty, stripe set. SVM 240 and RAID XOR engine 241 may then reconstruct the information on the stripes of the failed disk drive 211-213 (and thus, also on the failed virtual drive 231-233). Once this reconstruction is complete, the virtual volumes 250-252 associated with the failed disk drive 211-213 are back in a normal (i.e., non-degraded) configuration.

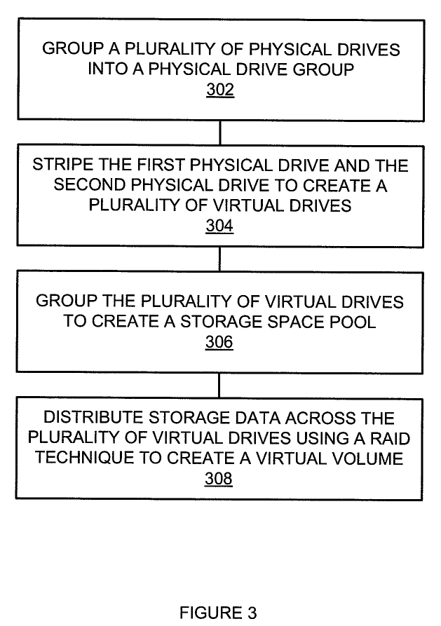

FIG. 3 is a flowchart illustrating a method of providing a virtual volume to a host. The steps of FIG. 3 may be performed by one or more elements of storage system 100 or storage system 200.

A plurality of physical drives are grouped into a physical drive group (302). For example, DPL 220 may group disk drives 211-213 into drive group 210. A first physical drive and a second physical drive may be striped to create a plurality of virtual drives (304). For example, disk drive 211 and disk drive 212 may be striped by DPL 220 to create and project virtual drives 231 and 232 to SVM 240.

The plurality of virtual drives are grouped to create a storage space pool (306). For example, virtual drive 231 and virtual drive 232 may be grouped by SVM 240 to create storage pool 230. Storage data is distributed across the plurality of virtual drives using at least one RAID technique to create a virtual volume (308). For example, storage data D0, D1, P0, and P1 may be distributed across virtual drives 231-233 to create virtual volume A 250.

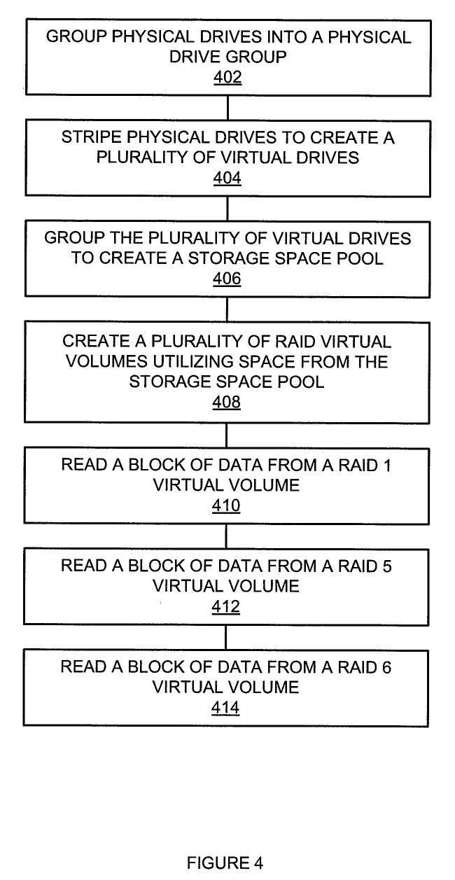

FIG. 4 is a flowchart illustrating a method of providing multiple RAID level configured virtual volumes to a host. The steps of FIG. 4 may be performed by one or more elements of storage system 100 or storage system 200.

Physical drives are grouped into a physical drive group (402). For example, DPL 220 may group disk drives 211-213 into drive group 210. Physical drives are striped (and/or spanned) to create a plurality of virtual drives (404). For example, disk drives 211-213 may be striped by DPL 220 to create and project virtual drives 231-233 to SVM 240.

The plurality of virtual drives are grouped to create a storage space pool (408). For example, virtual drives 231-235 may be grouped by SVM 240 to create storage pool 230. A plurality of RAID virtual volumes are created using space from the storage space pool (408). For example, virtual volumes 250-252 may be created from storage pool 230. Each of these virtual volumes may be configured with a RAID level. Each of these RAID levels may be different. In an example, virtual volume A may be configured at RAID level 5. Virtual volume B may be configured at RAID level 1. Virtual volume C may be configured at RAID level 6.

A block of data is read from a RAID 1 virtual volume (410). For example, a host computer may read a block of data from virtual volume B 251. This block of data may come from stripe 2342 on virtual disk 234.

A block of data is read from a RAID 5 virtual volume (412). For example, a host computer may read a block of data from virtual volume A 250. This block of data may come from stripe 2312 on virtual disk 231. This block of data may come from partition 2112 on disk drive 211.

A block of data is read from a RAID 6 virtual volume (414). For example, a host computer may read a block of data from virtual volume C 252. This block of data may come from stripe 2320 on virtual disk 232. This block of data may come from partition 2122 on disk drive 212.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of providing virtual volumes to at least one host, comprising:
grouping a plurality of physical drives into a physical drive group, wherein the plurality of physical drives comprises at least a first physical drive and a second physical drive;
striping at least the first physical drive and the second physical drive to create a plurality of virtual drives comprising at least a first virtual drive and a second virtual drive wherein the first virtual drive comprises storage space residing on the first physical drive and the second virtual drive comprises storage space residing on the second physical drive; and,
distributing storage data across at least the first virtual drive and the second virtual drive using at least one redundant array of independent disks (RAID) technique to create a plurality of virtual volumes comprising at least a first virtual volume and a second virtual volume.

2. The method of claim 1, further comprising:
grouping the plurality of virtual drives to provide a storage space pool.

3. The method of claim 1, wherein the first virtual volume is configured at a first RAID level and the second virtual volume is configured at a second RAID level.

4. The method of claim 2, further comprising:
in response to a failed physical drive that corresponds to a failed virtual drive, allocating a stripe set from said storage space pool that is equivalent to said failed virtual drive; and,
storing, on said stripe set, reconstructed information that was previously stored on said failed physical drive.

5. The method of claim 4, further comprising:
copying information stored on said stripe set to a replacement physical drive that has replaced said failed physical drive.

6. The method of claim 2, wherein storage space from the storage space pool is dynamically allocated to the plurality of virtual drives.

7. The method of claim 1, wherein the first RAID technique comprises:
retrieving a first block of data from the first virtual drive;
retrieving a second block of data from the second virtual drive; and,
retrieving a parity block of data from a third virtual drive.

8. The method of claim 1, wherein the first RAID technique comprises:
retrieving a first block of data from the first virtual drive;
retrieving a mirrored copy of the first block of data from the second virtual drive.

9. The method of claim 1, wherein the first RAID technique comprises:
retrieving a first block of data from the first virtual drive;
retrieving a second block of data from the second virtual drive;
retrieving a third block of data from a third virtual drive;
retrieving a first parity block of data from a fourth virtual drive; and,
retrieving a second parity block of data from a fifth virtual drive.

10. A storage system, comprising:
a physical drive grouper configured to provide a plurality of virtual drives that stripes a plurality of physical disks to provide a storage pool that utilizes RAID level 0;
a storage virtualization manager configured to provide at least a first virtual volume to a first host that stripes the plurality of virtual drives to configure the first virtual volume with a first RAID level.

11. The storage system of claim 10, wherein the first RAID level is greater than zero.

12. The storage system of claim 10, wherein the storage virtualization manager stripes the plurality of virtual drives to provide the first virtual volume with RAID level 1.

13. The storage system of claim 10, wherein the storage virtualization manager stripes the plurality of virtual drives to provide the first virtual volume with RAID level 5.

14. A computer readable medium having instructions stored thereon for providing virtual volumes to at least one host that, when executed by a computer, at least direct the computer to:
group a plurality of physical drives into a physical drive group, wherein the plurality of physical drives comprises at least a first physical drive and a second physical drive;
stripe storage data across at least the first physical drive and the second physical drive to create a plurality of virtual drives comprising at least a first virtual drive and a second virtual drive; and,
distribute storage data across at least the first virtual drive and the second virtual drive using at least one redundant array of independent disks (RAID) technique to create a plurality of virtual volumes comprising at least a first virtual volume and a second virtual volume.

15. The computer readable medium of claim 14, wherein the method, further comprises:
grouping the plurality of virtual drives to provide a storage space pool.

16. The computer readable medium of claim 14, wherein the first virtual volume is configured at a first RAID level and the second virtual volume is configured at a second RAID level.

17. The computer readable medium of claim 14, wherein the method, further comprises:
in response to a failed physical drive that corresponds to a failed virtual drive, allocating a stripe set from said storage space pool that is equivalent to said failed virtual drive; and,
storing, on said stripe set, reconstructed information that was previously stored on said failed physical drive.

18. The computer readable medium of claim 17, wherein the method, further comprises:
copying information stored on said stripe set to a replacement physical drive that has replaced said failed physical drive.

19. The computer readable medium of claim 15, wherein storage space from the storage space pool is dynamically allocated to the plurality of virtual drives.

20. The computer readable medium of claim 14, wherein the first RAID technique comprises:
retrieving a first block of data from the first virtual drive;
retrieving a second block of data from the second virtual drive; and,
retrieving a parity block of data from a third virtual drive.
